(19) United States
(12) Patent Application Publication
(10) Pub. No.: US 2020/0134872 A1
(43) Pub. Date: Apr. 30, 2020

(54) AUTOMATIC CALIBRATION METHOD AND APPARATUS FOR ONBOARD CAMERA

(71) Applicant: Baidu Online Network Technology (Beijing) Co., Ltd, Beijing (CN)

(72) Inventors: Yao Feng, Beijing (CN); Xianjin Zhuo, Beijing (CN); Zhipeng Zhou, Beijing (CN); Bing Li, Beijing (CN); Binglin Zhang, Beijing (CN)

(73) Assignee: Baidu Online Network Technology (Beijing) Co., Ltd., Beijing (CN)

(21) Appl. No.: 16/668,015

(22) Filed: Oct. 30, 2019

(30) Foreign Application Priority Data
Oct. 31, 2018 (CN) 201811289485.5

(51) Int. Cl. G06T 7/80; H04N 5/232; B60R 11/04

(52) U.S. Cl. CPC G06T 7/80; B60R 11/04; H04N 5/232941; H04N 5/23206

(57) ABSTRACT

An automatic calibration method for an onboard camera is provided, the automatic calibration method includes: receiving a calibration start command, by a vehicle equipped with the onboard camera at a predetermined position; capturing an image of a target with the onboard camera, and calibrating a parameter of the onboard camera according to the captured image; and in a case that the onboard camera is calibrated, automatically writing the calibrated parameter of the onboard camera into a configuration file.

### CROSS-REFERENCE TO RELATED APPLICATION

This application claims priority to Chinese Patent Application No. 201811289485.5, filed on Oct. 31, 2018, which is hereby incorporated by reference in its entirety.

### TECHNICAL FIELD

The present disclosure relates to the field of vehicles, and in particular to an automatic calibration method and apparatus for an onboard camera.

### BACKGROUND

With the rapid development of computer vision technology, onboard cameras are increasingly being used in vehicles. For example, onboard cameras may assist in automatic driving, Augmented Reality (AR) navigation, auxiliary prompts regarding safety issues and the like. This technology allows a driver to drive easily and get to know the peripheral situation of a vehicle so as to reduce accidents.

In order for the camera to work properly, it is necessary to determine an external parameter of the camera by calibration, that is, to determine the orientation of the camera.

The current solution goes as follows. For example, after an Automatic Data Acquisition System (ADAS) camera is installed in a vehicle, the vehicle is driven to a designated position, and a calibration application is started by manually clicking “calibration” in the vehicle. After a calibration process is performed and the result is generated, it is necessary to manually write the calibration result into a configuration file.

There are several obvious problems in the existing technology: (1) all operations require to be implemented manually; (2) calibration result requires to be manually written into a AR navigation configuration file, which potentially has the risk of being mistakenly written; and (3) it takes a quite while from the start of the calibration application to the time of obtaining calibration result.

The above is only a technical situation known to the inventors, which does not necessarily represent the existing technology on which the present disclosure is based.

### SUMMARY

In order to solve one or more of the problems in the existing technology, an automatic calibration method for an onboard camera is provided according to an embodiment of the present disclosure, the automatic calibration method includes: receiving a calibration start command, by a vehicle equipped with the onboard camera at a predetermined position; capturing an image of a target with the onboard camera, and calibrating a parameter of the onboard camera according to the captured image; and in a case that the onboard camera is calibrated, automatically writing the calibrated parameter of the onboard camera into a configuration file.

According to an aspect of the disclosure, the calibrating a parameter of the onboard camera according to the captured image includes: calculating a pitch angle and a yaw angle of the onboard camera.

According to an aspect of the disclosure, the calibrating a parameter of the onboard camera according to the captured image includes: calibrating the parameter of the onboard camera according to the Direct Linear Transformation (DLT), Tsai two-step approach or a Zhang Zhengyou camera calibration method.

According to one aspect of the disclosure, the receiving a calibration start command includes: receiving, by an onboard diagnostic system or a micro control unit, the calibration start command from a handheld device communicatively coupled to the vehicle; and sending the calibration start command via a Controller Area Network (CAN) bus to a calibration application.

According to one aspect of the disclosure, the receiving a calibration start command includes: receiving, by an onboard diagnostic system or a micro control unit, a calibration start command from a handheld device communicatively coupled to the vehicle; sending the calibration start command on a Controller Area Network (CAN) bus; and monitoring, by a calibration application, the calibration start command on the CAN bus.

According to an aspect of the disclosure, the automatic calibration method further includes: displaying a message of successful calibration on a screen in response to the calibration of the onboard camera.

According to an aspect of the disclosure, the automatic calibration method further includes: determining a failure calibration of the onboard camera, in a case that the pitch angle or the yaw angle exceeds respective threshold value, or in a case that the calibrated parameter of the onboard camera is not returned over a predetermined period of time.

According to an aspect of the disclosure, the automatic calibration method further includes: adjusting a position of the vehicle and/or a position of the onboard camera; and recalibrating in response to a failure calibration of the onboard camera.

An automatic calibration apparatus for an onboard camera is provided according to an embodiment of the present disclosure, the automatic calibration apparatus includes: one or more processors; a storage device configured to store one or more programs; an onboard camera configured to capture an image of a target, wherein the one or more programs, when executed by the one or more processors, cause the one or more processors to implement the automatic calibration method as described above.

An automatic calibration apparatus for an onboard camera is provided according to an embodiment of the present disclosure, the automatic calibration apparatus includes: a receiving unit configured to receive a calibration start command, by a vehicle equipped with the onboard camera at a predetermined position; a capturing unit configured to capture an image of a target with the onboard camera, and calibrate a parameter of the onboard camera according to the captured image; a writing unit configured to, in a case that the onboard camera is calibrated, automatically write the calibrated parameter of the onboard camera into a configuration file.

A non-transitory computer-readable storage medium is provided according to an embodiment of the present disclosure, including computer executable instructions stored thereon, wherein the executable instructions, when executed by a processor, causes the processor to implement the automatic calibration method as described above.

The disclosure mainly realizes fast and automatic calibration on an external parameter of an Automatic Data Acquisition System (ADAS) camera in a workshop. The embodiments of the disclosure, which are easy to learn and easy to use, can automate the whole process, reduce the training cost of workers, decrease the probability of making mistakes in writing an external parameter, and improve the efficiency of calibration on an external parameter of the camera.

The above summary is for the purpose of illustration only and is not intended to be limiting. In addition to the illustrative aspects, embodiments and features described above, further aspects, embodiments and features of the present disclosure will be readily apparent.

### BRIEF DESCRIPTION OF THE DRAWINGS

The appended drawings are intended to provide a further understanding of the disclosure and constitute a part of the specification, which, in conjunction with the embodiments of the present disclosure, are used to illustrate the specification and should not be construed as limiting the scope of present disclosure. In the drawings:

FIG. 1 shows a flow chart of an automatic calibration method for an onboard camera according to the first embodiment of the present disclosure;

FIG. 2 schematically shows a vehicle is parked at a predetermined position;

FIG. 3 schematically shows a pitch angle and a yaw angle;

FIG. 4 shows a flow chart of an automatic calibration method for an onboard camera according to the second embodiment of the present disclosure;

FIG. 5 shows a schematic diagram of an automatic calibration apparatus for an onboard camera according to the third embodiment of the present disclosure;

FIG. 6 shows a schematic diagram of an automatic calibration apparatus for an onboard camera according to the fourth embodiment of the present disclosure;

FIG. 7 shows a block diagram of a computer program product according to the fifth embodiment of the present disclosure.

### DETAILED DESCRIPTION OF THE EMBODIMENTS

In the following, only certain embodiments are briefly described. As can be recognized by those skilled in the art, various modifications may be made to the described embodiments without departing from the spirit or scope of present disclosure. Therefore, the drawings and the description are substantially regarded as exemplary intrinsically rather than restrictive.

In the description of the present disclosure, it is to be understood that the terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate the orientation or positional relationship which is based on the orientation or positional relationship shown in the drawings, and is merely for convenience of describing the present disclosure and simplification of the description, and does not indicate or imply the indicated apparatus or elements must have a particular orientation, be constructed and operated in a particular orientation, and therefore should not be construed as limitations to the disclosure. In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

In the present disclosure, the terms “mounting”, “connecting”, “coupling”, “fixing” and the like should be understood in a broad sense unless specifically defined or limited, for example, as a fixed or detachable connection, an integral connection, a mechanical or electrical connection, or communication, a direct connection, an indirect connection through an intermediary, the internal communication of two components, or the interaction between two components. Those of ordinary skill in the art can understand the specific meanings of the above terms in the present disclosure according to specific circumstances.

In the present disclosure, the first feature being on or under the second feature may include direct contact of the first and second features, and may also include indirect contact of the first and second features through another feature, unless expressly specified or limited. Also, the first feature being “on”, “above”, and “over” the second feature may include the first feature being directly or diagonally above the second feature, or merely indicates that the first feature is higher than the second feature in height. The first feature being “under”, “below”, and “beneath” the second feature may include the first feature being directly or diagonally below the second feature, or merely indicates that the first feature is lower than the second feature in height.

The following disclosure provides many different embodiments or examples for implementing different structures of the present disclosure. In order to simplify the disclosure of the present disclosure, the components and settings of specific examples are described below. Of course, they are merely examples and it is not intended to limit the present disclosure. In addition, the present disclosure may repeat reference numerals and/or reference letters in different examples. This repetition is for the purpose of simplification and clarity and does not itself indicate the relationship between the various embodiments and/or settings discussed. In addition, the present disclosure provides examples of various specific processes and materials, but those skilled in the art may be aware of applications of other processes and/or use of other materials.

The preferred embodiments of the present disclosure are described in conjunction with the accompanying drawings. It should be noted that the preferred embodiments described herein are intended to illustrate and explain the disclosure instead of limiting the scope of present disclosure.

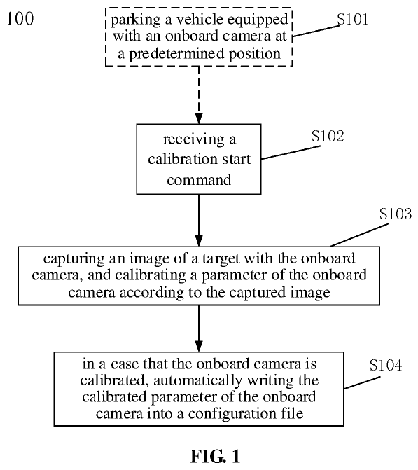

An automatic calibration method 100 for an onboard camera according to the first embodiment of the present disclosure will now be described with reference to FIG. 1.

As shown in FIG. 1, in S102, a calibration start command is received by a vehicle equipped with the onboard camera at a predetermined position. At the predetermined position, the onboard camera is, for example, directly facing the target for calibration, such as a checkerboard pattern. FIG. 2 schematically shows a vehicle is parked at a predetermined position, where an onboard camera is facing a checkerboard pattern in front of the vehicle.

According to an embodiment, a handheld device communicatively coupled to a vehicle electronic system sends a calibration start command, so as to notify an onboard diagnostic (OBD) system or a micro-control unit (MCU) to perform a calibration process. Specifically, the calibration start command can be sent to the onboard diagnostic system or the micro control unit via the Bluetooth protocol by the handheld device. After receiving the calibration start command, the onboard diagnostic system or the micro control unit notifies a system framework, via a Controller Area Network (CAN) bus, to send an Intent command with a CALIBRATE_CAMERA_EXTERNAL action. After receiving this Intent command, the calibration application will start by itself. Alternatively, the calibration application will start by itself through monitoring a 0x7371 message reported via the CAN.

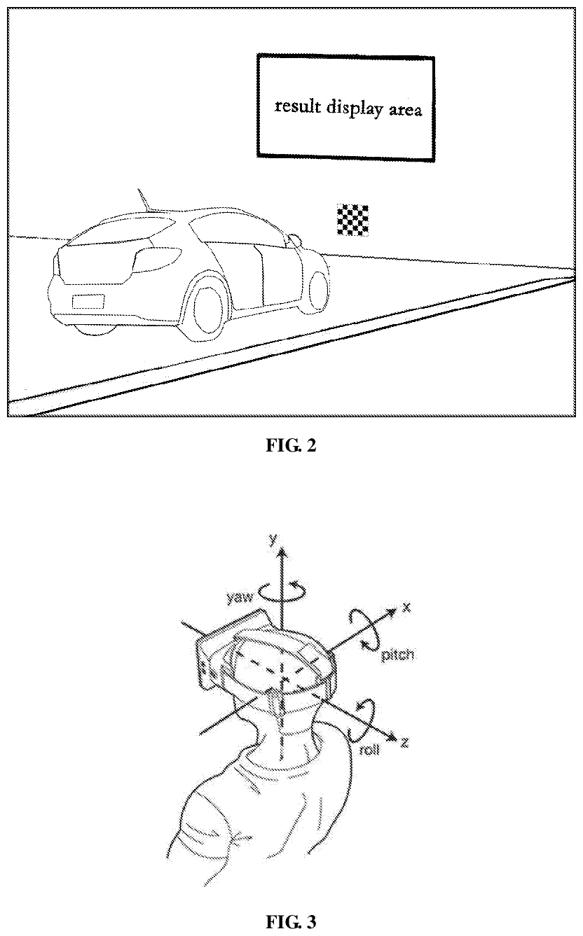

In S103, an image of a target, for example, a checkerboard pattern, is captured with the onboard camera, and a parameter of the onboard camera is calibrated according to the captured image. Those skilled in the art can perform a calibration calculation on an external parameter of the camera in various ways, such as one or more of Direct Linear Transformation (DLT), Tsai two-step approach, or Zhang Zhengyou camera calibration method. The calibrating a parameter of the onboard camera according to the captured image includes calculating a pitch angle (pitch) and a yaw angle (yaw) of the onboard camera. FIG. 3 schematically shows a pitch angle (pitch) and a yaw angle (yaw). In FIG. 3, the camera is worn on a user's head, which is used to schematically illustrate the pitch angle and yaw angle of the camera, and does not illustrate the usage scenario of the present disclosure.

In S104, in a case that the onboard camera is calibrated, the calibrated parameter of the onboard camera is automatically written into a configuration file. For example, the pitch angle (pitch) and the yaw angle (yaw) of the onboard camera calculated in S103 are written into the configuration file. According to a preferred implementation, the configuration file is a configuration file for AR navigation. S104 can be automatically triggered by setting a corresponding logic condition. For example, if it is determined that the calibration is successful, the write operation is triggered and the calibration calculation result is written into the configuration file, thereby realizing automation of the entire process.

The automatic calibration method 100 may also include S101 before S102. In S101, the vehicle equipped with the onboard camera is parked at the predetermined position.

According to a preferred implementation of the present disclosure, after the calculation of S103 is completed, an application layer sends a message carrying the calibration result on the CAN bus. After receiving the message from the application layer, the result is parsed on the CAN bus, and then is notified to a screen device after the parsing is completed. The result of the successful or failed calibration will then be displayed on a screen in a workshop, e.g., a result display area as shown in FIG. 2.

According to a preferred implementation of the disclosure, if the pitch angle (pitch) and/or the yaw angle (yaw) exceed respective thresholds (e.g., more than 10 degrees), then it is determined that the calibration has failed. The respective thresholds of the pitch and yaw angles can be set and adjusted by the user. Alternatively, when the result is not returned over a predetermined period of time in S103, it is determined that the calibration has failed. The predetermined period of time is, for example, 30 seconds. For example, the image is not captured successfully, or the image is so severely deformed that the checkerboard cannot be detected, which leads to the time-out of the calculation.

According to a preferred implementation of the present disclosure, the automatic calibration method 100 further includes: adjusting a position of the vehicle and/or a position of the onboard camera; and recalibrating in response to a failure calibration of the onboard camera.

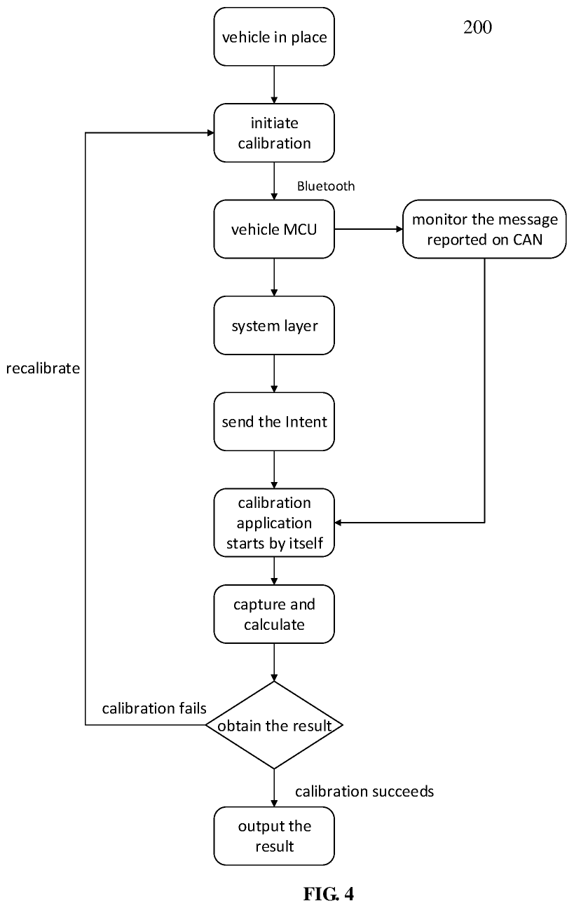

FIG. 4 illustrates an automatic calibration method 200 for an onboard camera according to the second embodiment of the present disclosure. As shown in FIG. 4, after the vehicle is parked in place, the calibration process is initiated. For example, a handheld device can be used to send a calibration start command to the onboard diagnostic system or the micro control unit of the vehicle via the Bluetooth protocol. After receiving the calibration start command, the onboard diagnostic system or the micro control unit notifies a system layer, via the CAN bus, to send an Intent command with the CALIBRATE_CAMERA_EXTERNAL action. After receiving this Intent command, the calibration application will start by itself. Alternatively, the calibration application will start by itself through monitoring the 0x7371 message reported on the CAN.

After the calibration application is started, the onboard camera captures an image of the pattern for use in the calibration, and a calibration calculation is performed. If the calibration is successful, the result of the calibration calculation is automatically written into a configuration file. For example, the pitch angle (pitch) and the yaw angle (yaw) of the onboard camera calculated in S103 are written into the configuration file, and the result of the successful calibration is displayed on the screen. According to a preferred implementation, the configuration file is a configuration file for AR navigation.

If the calibration fails, recalibration will be performed. Regarding the determination whether calibration is successful or fails, the determination can be made based on the pitch angle and the yaw angle. If the pitch angle (pitch) and/or the yaw angle (yaw) exceed respective thresholds (for example, 10 degrees), it is determined that the calibration has failed. The thresholds of the pitch and yaw angles can be set and adjusted by the user. Alternatively, it can be determined by setting the threshold of time period in which the calibration calculation is performed. For example, if the results are not returned over a predetermined period of time, it is then determined that the calibration has failed. The predetermined period of time is, for example, 30 seconds.

FIG. 5 illustrates an automatic calibration apparatus 300 for an onboard camera according to the third embodiment of the present disclosure. The automatic calibration apparatus 300 includes: one or more processors 302; a storage device 303, configured to store one or more programs; an onboard camera 301, configured to capture an image of a target, wherein the one or more programs, when executed by the one or more processors, cause the one or more processors to implement the automatic calibration method 100 or 200 of the present disclosure.

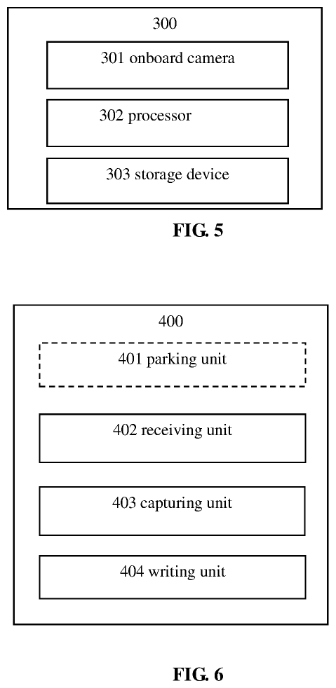

FIG. 6 shows an automatic calibration apparatus 400 for an onboard camera according to the fourth embodiment of the present disclosure. As shown in FIG. 6, the automatic calibration apparatus 400 includes: a receiving unit 402 configured to receive a calibration start command, by a vehicle equipped with the onboard camera at a predetermined position; a capturing unit 403 configured to capture an image of a target with the onboard camera, and calibrate a parameter of the onboard camera according to the captured image; a writing unit 404 configured to, in a case that the onboard camera is calibrated, automatically write the calibrated parameter of the onboard camera into a configuration file. The automatic calibration apparatus 400 may also include a parking unit 401 configured to park the vehicle equipped with the onboard camera at the predetermined position.

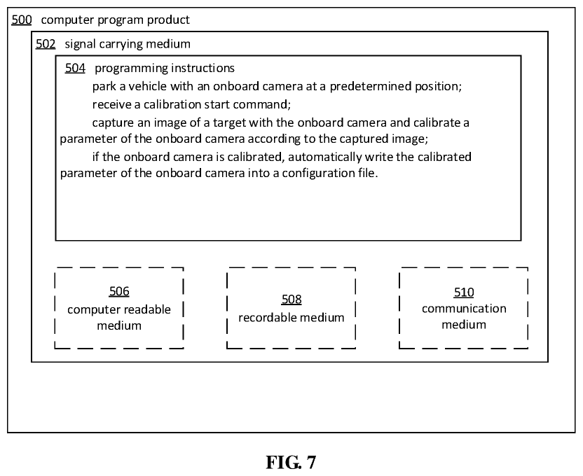

FIG. 7 shows a block diagram of a computer program product 500 according to the fifth embodiment of the present disclosure. A signal carrying medium 502 can be implemented as or include a computer readable medium 506, a computer recordable medium 508, a computer communication medium 510, or a combination thereof, programming instructions 504 configured to execute all or some of the processes previously described. The instructions may include, for example, one or more executable instructions that cause one or more processors to perform the following processes: parking a vehicle with an onboard camera at a predetermined position; receiving a calibration start command; capturing an image of a target with the onboard camera and calibrating a parameter of the onboard camera according to the captured image; if the onboard camera is calibrated, automatically writing the calibrated parameter of the onboard camera into a configuration file.

The embodiments of the disclosure, which are easy to learn and easy to use, can automate the whole procedure, reduce the training cost of workers, decrease the probability of making mistakes in writing an external parameter, and improve the efficiency of calibration on an external parameter of the camera.

Any process or method descriptions described in flowcharts or otherwise herein may be understood as representing modules, segments or portions of code that include one or more executable instructions for implementing the steps of a particular logic function or process. The scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, apparatus, or apparatus (such as a computer-based system, a processor-included system, or other system that fetch instructions from an instruction execution system, apparatus, or apparatus and execute the instructions). For the purposes of this specification, a “computer-readable medium” may be any apparatus that can contain, store, communicate, propagate, or transport the program for use by or in connection with the instruction execution system, apparatus, or apparatus. The computer-readable medium described in the embodiments of present disclosure may be a computer-readable signal medium or a computer-readable storage medium or any combination thereof. More specific examples (not a non-exhaustive list) of the computer-readable media include the following: electrical connections (electronic devices) having one or more wires, a portable computer disk cartridge (magnetic apparatus), random access memory (RAM), read only memory (ROM), erasable programmable read only memory (EPROM or flash memory), optical fiber devices, and portable read only memory (CDROM). In addition, the computer-readable medium can even be paper or other suitable medium upon which the program can be printed, as it may be read, for example, by optical scanning of the paper or other medium, followed by editing, interpretation or, where appropriate, process otherwise to electronically obtain the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included therein.

In addition, each of the functional units in the embodiments of the present application may be integrated in one processing module, or each of the units may exist alone physically, or two or more units may be integrated in one module. The above-mentioned integrated module can be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. An automatic calibration method for an onboard camera, comprising:
receiving a calibration start command, by a vehicle equipped with the onboard camera at a predetermined position;
capturing an image of a target with the onboard camera, and calibrating a parameter of the onboard camera according to the captured image; and
in a case that the onboard camera is calibrated, automatically writing the calibrated parameter of the onboard camera into a configuration file.

2. The automatic calibration method according to claim 1, wherein the calibrating a parameter of the onboard camera according to the captured image comprises:
calculating a pitch angle and a yaw angle of the onboard camera.

3. The automatic calibration method according to claim 1, wherein the calibrating a parameter of the onboard camera according to the captured image comprises:
calibrating the parameter of the onboard camera according to a Direct Linear Transformation (DLT), Tsai two-step approach or a Zhang Zhengyou camera calibration method.

4. The automatic calibration method according to claim 1, wherein the receiving a calibration start command comprises:
receiving, by an onboard diagnostic system or a micro control unit, the calibration start command from a handheld device communicatively coupled to the vehicle; and
sending the calibration start command via a Controller Area Network (CAN) bus to a calibration application.

5. The automatic calibration method according to claim 1, wherein the receiving a calibration start command comprises:
receiving, by an onboard diagnostic system or a micro control unit, a calibration start command from a handheld device communicatively coupled to the vehicle;
sending the calibration start command on a Controller Area Network (CAN) bus; and
monitoring, by a calibration application, the calibration start command on the CAN bus.

6. The automatic calibration method according to claim 1, further comprising: displaying a message of successful calibration on a screen in response to the calibration of the onboard camera.

7. The automatic calibration method according to claim 2, further comprising:
determining a failure calibration of the onboard camera, in a case that the pitch angle or the yaw angle exceeds respective threshold value, or in a case that the calibrated parameter of the onboard camera is not returned over a predetermined period of time.

8. The automatic calibration method according to claim 1, further comprising:
adjusting a position of the vehicle and/or a position of the onboard camera; and recalibrating in response to a failure calibration of the onboard camera.

9. An automatic calibration apparatus for an onboard camera, comprising:
one or more processors;
a storage device configured to store one or more programs;
the onboard camera configured to capture an image of a target;
wherein the one or more programs, when executed by the one or more processors, cause the one or more processors to:
receive a calibration start command, by a vehicle equipped with the onboard camera at a predetermined position;
capture the image of the target with the onboard camera, and calibrate a parameter of the onboard camera according to the captured image; and
in a case that the onboard camera is calibrated, automatically write the calibrated parameter of the onboard camera into a configuration file.

10. The automatic calibration apparatus according to claim 9, wherein the one or more programs, when executed by the one or more processors, cause the one or more processors further to:
calculate a pitch angle and a yaw angle of the onboard camera.

11. The automatic calibration apparatus according to claim 9, wherein the one or more programs, when executed by the one or more processors, cause the one or more processors further to:
calibrate the parameter of the onboard camera according to a Direct Linear Transformation (DLT), Tsai two-step approach or a Zhang Zhengyou camera calibration method.

12. The automatic calibration apparatus according to claim 9, wherein the one or more programs, when executed by the one or more processors, cause the one or more processors further to:
receive, by an onboard diagnostic system or a micro control unit, the calibration start command from a handheld device communicatively coupled to the vehicle; and
send the calibration start command via a Controller Area Network (CAN) bus to a calibration application.

13. The automatic calibration apparatus according to claim 9, wherein the one or more programs, when executed by the one or more processors, cause the one or more processors further to:
receive, by an onboard diagnostic system or a micro control unit, a calibration start command from a handheld device communicatively coupled to the vehicle;
send the calibration start command on a Controller Area Network (CAN) bus; and
monitor, by a calibration application, the calibration start command on the CAN bus.

14. The automatic calibration apparatus according to claim 9, wherein the one or more programs, when executed by the one or more processors, cause the one or more processors further to:
display a message of successful calibration on a screen in response to the calibration of the onboard camera.

15. The automatic calibration apparatus according to claim 10, wherein the one or more programs, when executed by the one or more processors, cause the one or more processors further to:
determine a failure calibration of the onboard camera, in a case that the pitch angle or the yaw angle exceeds respective threshold value, or in a case that the calibrated parameter of the onboard camera is not returned over a predetermined period of time.

16. The automatic calibration apparatus according to claim 9, wherein the one or more programs, when executed by the one or more processors, cause the one or more processors further to:
adjust a position of the vehicle and/or a position of the onboard camera; and recalibrate in response to a failure calibration of the onboard camera.

17. A non-transitory computer-readable storage medium comprising computer executable instructions stored thereon, wherein the executable instructions, when executed by a processor, causes the processor to implement the automatic calibration method of claim 1.
